(19) United States
(12) Patent Application Publication
(10) Pub. No.: US 2026/0099549 A1
(43) Pub. Date: Apr. 9, 2026

(54) GENERATIVE MODEL-BASED AUTOMATIC REPORT GENERATION AND UPDATING

(71) Applicant: Newton Principle Agency Corp., Washington, DC (US)

(72) Inventors: Clinton Richard Irvin, Waverly Hall, GA (US); Taehee Jeong, Cupertino, CA (US); Mehmet Vergili, Livermore, CA (US); Martin Richard Fisher, JR., Maryland, DC (US); Eva Cicinyte, Manhattan Beach, CA (US)

(21) Appl. No.: 18/908,023

(22) Filed: Oct. 7, 2024

(51) Int. Cl. G06F 16/9038; G06F 16/903

(52) U.S. Cl. CPC G06F 16/9038; G06F 16/90335

(57) ABSTRACT

Systems and methods are disclosed herein for generative model-based automatic report generation and updating. A report generation system uses RAG search techniques and machine-learned models to generate reports responsive to user-specified prompts using data sets retrieved from third-party data sources. The system continually monitors the third-party data sources to identify changes to the underlying data sets by sending, to each data source, a first database query specifying an historical time period and a second database query specifying a recent time period. The system compares the responsive data sets, and if the system determines that an update condition has occurred, the system automatically generates and transmits to the user an updated report notifying the user of the change or development relevant to the underlying query.

### TECHNICAL FIELD

The disclosure generally relates to a report generation system, and more particularly to a report generator that uses Large Language Models (LLMs) and Retrieval Augmented Generation (RAG) search techniques to automatically update generated reports responsive to detecting updated source information.

### BACKGROUND

Digital distribution channels may be used to disseminate a wide variety of content to users. Both individuals and enterprise users rely on timely and relevant streams of information for both personal and professional use. Conventional systems cater to this need by providing users with information on diverse subjects of interest. Whether it's a financial analyst tracking market trends or an executive-actively monitoring competitors, conventional systems provide platforms for users to access information on diverse topics that are personally relevant. However, the scope and relevance of the information being delivered greatly depend on the systems' capacity to collect, analyze, and extrapolate data.

While some of these conventional systems and services provide data-driven reports to users, one common drawback is the inherent static nature of their output. More often than not, the reports generated by these systems rely on a static data model, which means that the data input, once processed and reported, remains unchanged, causing reports to become outdated quickly. As a result, such reports can lose their usefulness, particularly in contexts where the subject of the report is a rapidly developing or changing area.

### SUMMARY

Systems and methods are disclosed herein for generative model-based automatic report generation and updating. A report generation system receives a report request from a user defining a prompt, such as a topic of interest or one or more specific queries, and at least one report parameter, such as a report interval, geographic scope, or report delivery format. A semantic analyzer applies an embedding model to convert the prompt into a semantic embedding vector and computes similarity scores (e.g., cosine similarity) between the vector representing the prompt and vectors representing third-party data sources associated with the report generation system. The semantic analyzer uses the generated scores to identify a corpus of third-party data sources to query for data relevant to the report request. A data query engine sends database queries to the identified third-party data sources and sends the responsive data sets to a report generator, which uses LLMs to translate the data sets into a narrative response to the user prompt. An interface of the report generation system transmits the generated report to the user according to the user-specified report parameters.

A comparison and update module of the report generation system monitors the queried data sources associated with a previously generated report for new data relevant to the user query to identify significant changes occurring after a most recent report (e.g., the initial report) was generated. To do so, the data query engine sends first and second database queries to the third-party data sources where a first database query represents a larger, historical time frame (e.g., data generated within the past three weeks minus the most recent day), and a second database query represents a smaller, more recent time frame (e.g., real-time data as it is received, data generated within the past 10 minutes, past hour, past day, and the like). In one embodiment, the comparison and update module uses provided event triggers that define conditions related to the questions that trigger a report. An agentic AI agent assesses if the report conditions are met by comparing the historic and recent record sets and applying a heuristic based judgment procedure that provides a dichotomous result (yes/no). If the report conditions are met, the system then generates an updated report notifying the user of the observed change relevant to the trigger monitor specified and the user query. Alternatively, the comparison and update module calculates similarity metrics comparing the data sets received responsive to the first and second database queries, and if the calculated metrics exceed a threshold value, the comparison and update module determines that an update condition has occurred and automatically generates and sends to the user an updated report notifying the user of the delta between the first and the second data sets, that is, the changes in the underlying data representing a new development or change relevant to the user query.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. (FIG.) 1 is a block diagram of a system environment in which a report generation system operates, in accordance with one embodiment.

FIG. 2 is a block diagram of the report generation system of FIG. 1, in accordance with one embodiment.

FIG. 3 is example report request interface displayed on a user device of a user of the report generation system, in accordance with one embodiment.

FIG. 4 is an example report interface displayed on a user device of a user of the report generation system, in accordance with one embodiment.

FIG. 5 is a flow chart illustrating an example process for generating a report in response to a user query, in accordance with one embodiment.

FIG. 6 is a flow chart illustrating an example process for automatically updating a report responsive to detection of an update condition, in accordance with one embodiment.

FIG. 7 is a block diagram illustrating components of a computer used as part or all of the report generation system or the user device, in accordance with one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Report Generation System Environment

FIG. 1 is a block diagram of a system environment 100 in which a report generation system 110 operates, in accordance with one embodiment. In the embodiment shown in FIG. 1, the system environment 100 includes the report generation system 110, a user device 130 having a report generation application 135, a web browser 140, and an email application 145, and one or more third-party data sources 150, all connected via the network 120. In other embodiments, the system environment 100 contains different or additional elements. In addition, the functions may be distributed among the elements in a different manner than described. Moreover, while three third-party data sources 150 and a single user device 130 are shown in FIG. 1 to simply and clarify the description, in other embodiments, the system environment includes many third-party data sources 150 that interact with many user devices 130 associated with users of the report generation system 110.

FIG. 1 uses like reference numerals to identify like elements. A letter after a reference numeral, such as “150A,” indicates that the text refers specifically to the element having that particular reference numeral. A reference numeral in the text without a following letter, such as “150,” refers to any or all of the elements in the figures bearing that reference numeral. For example, “150” in the text refers to reference numerals “150A,” “150B,” and/or “150N” in the figures.

The report generation system 110 is a computer system (or group of computer systems) for generating and automatically updating reports based on data retrieved from a plurality of third-party data sources. The report generation system 110 can be a server, server group or cluster (including remote servers), or another suitable computing device or system of devices. Moreover, the report generation system 110 may be a centralized or a de-centralized system. For example, the operations can be performed at least in part by software applications of a de-centralized system installed on individual user devices 130.

The network 120 transmits data within the system environment 100. The network 120 may comprise any combination of local area and/or wide area networks, using both wired and/or wireless communication systems, such as the Internet. In some embodiments, the network 120 transmits data over a single connection (e.g., a data component of a cellular signal, or Wi-Fi, among others), and/or over multiple connections. In some embodiments, the network 120 uses standard communications technologies and/or protocols. For example, the network 120 includes communication links using technologies such as Ethernet, IEEE 802.11, 4G, 5G, code division multiple access (CDMA), digital subscriber line (DSL), and the like. Data exchanged over network 120 may be represented using any suitable format, such as hypertext markup language (HTML) or extensible markup language (XML). In some embodiments, the network 120 may include encryption capabilities to ensure the security of customer data. For example, encryption technologies may include secure sockets layers (SSL), transport layer security (TLS), virtual private networks (VPNs), and Internet Protocol security (IPsec), among others.

Through the network 120, the report generation system 110 can communicate with a user associated with a user device 130. A user can represent an individual, group, enterprise, or other entity that is able to interact with the report generation system 110 to view content and associated analytics. Each user can be associated with a username, email address, or other identifier that can be used by the report generation system 110 to identify the user and to control the ability of the user to request, view, and interact with reports or other content made available by the report generation system 110. In some embodiments, users can interact with the report generation system 110 through a user account with the report generation system 110 and the one or more user devices 130 accessible to the users.

A user device 130 is a computing device capable of receiving user input as well as transmitting and/or receiving data to the report generation system 110 via the network 120. For example, a user device can be a desktop or a laptop computer, a smartphone, tablet, or another suitable device. Each user device may have a screen for displaying content (e.g., videos, images, or other content items) or receiving user input (e.g., a touchscreen). User devices are configured to communicate via the network 120. In one embodiment, a user device executes an application, such as the report generation application 135, allowing a user of the user device to interact with the report generation system 110. Additionally or alternatively, a user can execute the web browser 140 to enable interaction between the user device 130 and the report generation system 110. In some embodiments, a single user can be associated with multiple user devices 130, and/or one user device 130 can be shared between multiple users who may, for example, log into a personal account on the user device 130 to access the report generation system 110. As discussed below, the user may receive initial and updated reports generated by the report generation system 110 via an email application 145 on the user device 130. In alternate embodiments, the user accesses generated reports via other reporting mechanisms, such as on a page displayed on the report generation application 135 or through a link to a web page provided via a messaging application on the user device 130.

One or more third-party data sources 150 are coupled to the network 120 for communicating with the report generation system 110. In one embodiment, a third-party data source 150 is a content provider, such as a news agency or similar entity, having one or more associated websites to which news stories and other content items are posted. These third-party data sources 150 are diverse, encompassing a wide range of content types from various industries and sectors, including but not limited to sports, politics, economics, technology, and entertainment. They may originate from different geographical regions, cultural perspectives, or specialized fields, contributing to a comprehensive and multifaceted dataset. Third-party data sources 150 may create and provide content of a single type (e.g., sports, politics, economics, etc.) or provide multiple types of content. A third-party data source 150 may upload content items to an associated website at specified intervals and/or as breaking news develops, ensuring timely and varied information flows into the system.

In one embodiment, the third-party data sources 150 are news outlets or other sources identified as trustworthy and popular in each of a plurality of geographies, such as countries, states, or other territories. For example, news content may be gathered from the top ten most popular and trustworthy or high-quality data sources of a specified number (e.g., 10, 15, 20, etc.) across multiple countries, such as countries having the highest gross domestic product (GDP) as determined by the report generation system 110, e.g., based on publicly available data. In another example, news stories are retrieved from a plurality of data sources in more granular geographies, such as each state in the United States, each province in Canada, etc.

In one embodiment, the report generation system 110 retrieves content from the same third-party data sources 150 regardless of the type of query specified by the user. For example, a reputable and popular news source may be queried for stories in multiple categories, such as Business, Politics, Sports, etc. Alternatively, the third-party data sources 150 may vary based on the relevant content category. For example, the report generation system 110 may query a reputable and popular sports website for sports news content but not any other content categories. The report generation system 110 stores identifying information for the selected third-party data sources 150 (and, optionally, associated categories of content) in the third-party data store 240 and may periodically add to, or update, the list of data sources 150.

The third-party data sources 150 additionally include one or more social networking platforms on which users interact with each other to view and share content items. Content items shared to the social networking platforms may include, for example, news stories, such as those created by the news agency third-party data sources 150. The social networking platforms may provide functionality that allows users to interact with and/or express a sentiment associated with a posted content item, e.g., by “liking” or “disliking” a content item, commenting on the content item, sharing the content item with other users, etc.

### Report Generation System

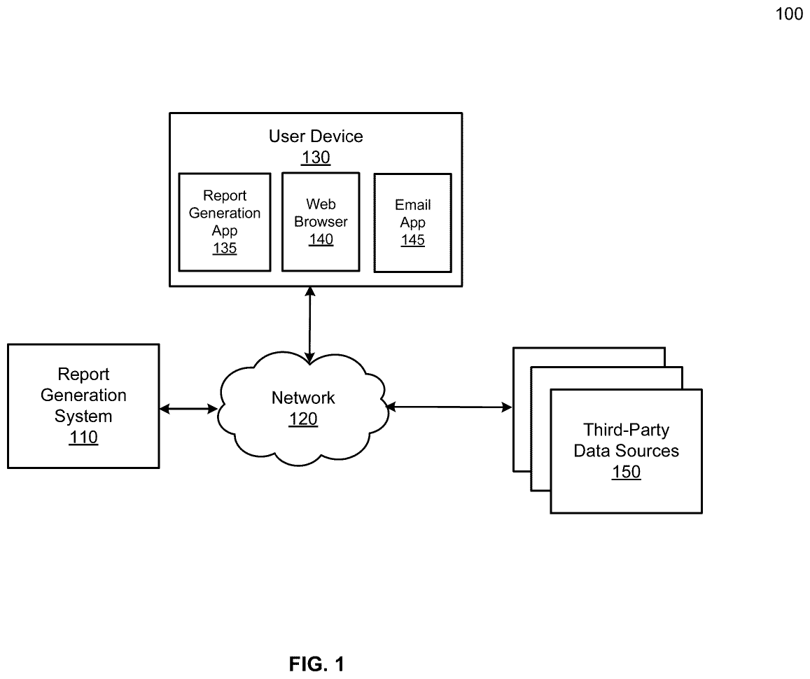

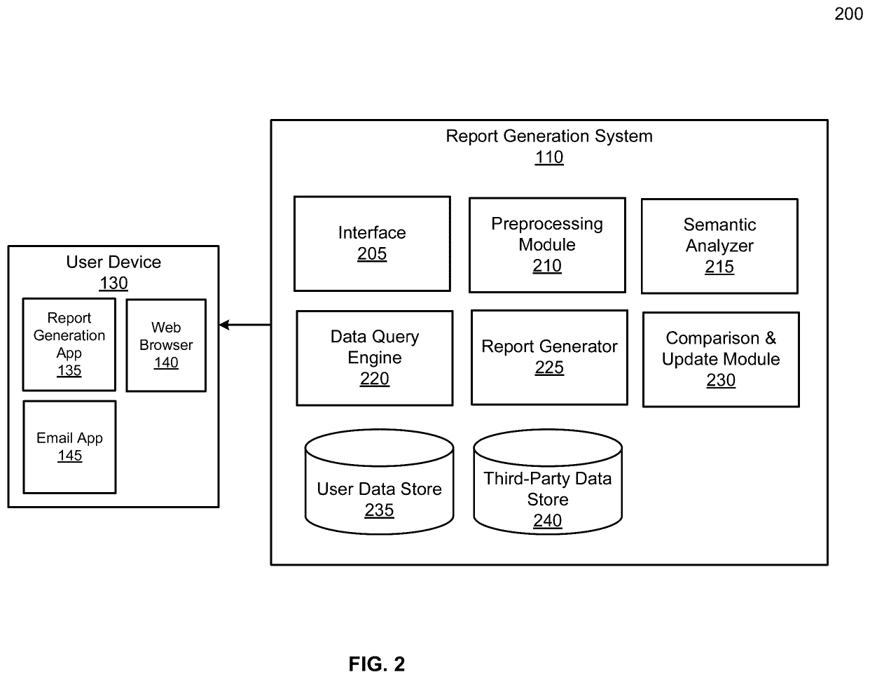

FIG. 2 is a block diagram of a report generation system 110 of FIG. 1, in accordance with one embodiment. The report generation system 110 includes or accesses local databases such as a user data store 235 and a third-party data store 240. Report generation system 110 includes software modules such as an interface 205, a preprocessing module 210, a semantic analyzer 215, a data query engine 220, a report generator 225, and a comparison and update module 230, and databases including a user data store 235 and a third-party data store 240. The report generation system 110 may have alternative configurations than shown in FIG. 2, including different, fewer, or additional components.

The interface 205 may include software and/or hardware components that enable the report generation system 110 to communicate with user devices or third-party platform servers through the network 120. For example, in various embodiments, the interface 205 is a web application that is run by a web browser, such as the browser 140, at a user device 130 or a software as a service platform that is accessible by the device 130 through the network 120. The interface 205 may be the front-end component of a mobile application or a desktop application, such as the report generation application 135. In one embodiment, the interface 205 may use application program interfaces (APIs) to communicate with user devices 130 or third-party data sources 150, which may include mechanisms such as web-hooks.

The interface 205 communicates with a user device 130 to onboard a user to the report generation system 110. For example, where the user is an employee or representative of an enterprise organization, the interface 205 may prompt the user to create a profile identifying the enterprise name, enterprise type, relevant industry, enterprise competitors (regional, national, or international), location(s), the user's job title, and the like. Profiles are stored in association with the user and the enterprise in the user data store 235.

After a user profile has been created, or in conjunction with providing the profile information, the user may submit a request to generate one or more reports on a specified prompt. In various embodiments, the prompt identifies a general area of interest (e.g., the Banking sector) and/or one or more specific queries (e.g., “What is the latest outlook on the Banking sector? How does Everyday Bank compare to competitors in the Banking sector in the US Southeast region?”). In addition to identifying a prompt, the user may specify one or more parameters for generation of the report, such as a report format (e.g., a narrative response in paragraph form, a bullet pointed list, etc.), a delivery format (e.g., a PDF report sent to the user's email address, a phone call or other audio output to the user device 130), a report interval (e.g., weekly, biweekly, monthly, etc.), a geographic report scope (e.g., international, national, regional, etc.), one or more preferred third-party data sources 150 (e.g., the New York Times, the Financial Times, etc.), one or more third-party data sources 150 to exclude, a report language, and the like.

The report parameters further include, in some embodiments, user input specifying one or more conditions triggering generation of an updated report (the “update conditions”), such as a threshold amount of change or number of changes to the factual states or conclusions in a most recent report, any change associated with a specified competitor, any new development to the factual states or conclusions reported by a specified data source, etc. Moreover, in some embodiments, the report generation system 110 identifies one or more suggested or default update conditions based on, for example, the relevant industry or the data sources upon which the report is based. As discussed in more detail below, when the comparison and update module 230 identifies that an update condition has occurred, the report generator 220 generates and provides to the user an update notification in a user-specified or default format. The update notification is typically provided outside of the periodic report interval (e.g., as a “Breaking News”-type update).

The interface 205 stores the report generation request in association with the user profile in the user data store 235 and sends the request to the preprocessing module 210, which performs preprocessing operations on the received prompt to optimize the prompt for input to the semantic analyzer 215. In one embodiment, the preprocessing operations include filtering out third-party data sources 150 to be queried in connection with report generation based on one or more of location, language, and user data source preferences. For example, where the user profile or report request indicates that the user is located in the United States and has specified that the report should be generated in English, the preprocessing module 210 filters the corpus of source material to include only English-language data sources. In another example, if the report request identifies a more granular geography of interest (e.g., the user has requested information about the Banking sector in the US Southeast region or in a specific state), the preprocessing module 210 filters out third-party data sources 150 associated with other geographies (e.g., different regions or states). Because third-party data sources 150 outside the United States may provide English-language content (for example), the preprocessing module 210 does not automatically remove data sources from countries outside the user's location absent the user specifying a report parameter limiting the report generation to data sources within the user's country. In yet another example, where the user has provided a report parameter identifying one or more data sources 150 to exclude, the preprocessing module removes the identified data source(s) 150 from the corpus of sources to be queried. Additional preprocessing steps may include one or more of tokenization of the prompt, lowercasing of the text in the prompt, stop word removal, stemming, keyword extraction, and spell checking and correction.

The preprocessing module 210 sends the optimized prompt to the semantic analyzer 215, which identifies a corpus of third-party data sources 150 to query for content (e.g., news articles) responsive to the report request. In one embodiment, the third-party data sources 150 150 are news outlets or other sources identified as trustworthy and popular in each of a plurality of geographies, such as countries, states, or other territories. For example, the data sources 150 might include, in one embodiment, a top ten most popular and trustworthy or high-quality data sources of a specified number (e.g., 10, 15, 20, etc.) across multiple countries, such as countries having the highest gross domestic product (GDP) as determined by the report generation system 110, e.g., based on publicly available data. The report generation system 110 stores identifying information for the third-party data sources 150 (and, optionally, associated categories of content available from the third-party data sources 150, such as Business, Politics, Law, Sports, etc.) in the third-party data store 240 and may periodically add to, or update, the list of data sources 150.

The semantic analyzer 215 dissects the optimized prompt by using one or more machine-learned models, such as a large language model (LLM) to identify at least one topic of interest within the query. For example, where the user query is “What is the current outlook on the banking sector in Southern California?”, the semantic analyzer 215 identifies “banking” as a first topic and “Southern California” as a second topic. As demonstrated in this example, identified topics may relate to a subject matter or a location of interest or be based on other categories (e.g., time frame, data sources, etc.).

In one embodiment, the semantic analyzer 215 employs an embedding model to identify relevant third-party data sources 150 for generating the report. The embedding model is applied to the user's query and translates the text of the query to numerical form that captures semantic content such that each word or phrase from the query is transformed into a numerical vector in a high-dimensional space. The embedding model also transforms each third-party data source 150 in the identified corpus of data sources 150 into a numerical vector, and the content corpus of each of the data sources 150 is similarly mapped into the high-dimensional vector space.

The semantic analyzer 215 compares the vector representing the user's query and the vectors representing each of the third-party data sources 150 and computes a similarity score (e.g., using cosine similarity or other distance metrics) for each of the third-party data sources 150 representing the similarity between the user's query and the contents of a respective third-party data source 150. In one embodiment, the semantic analyzer 215 uses the computed similarity scores to select data sources 150 to query for content responsive to the user prompt, for example, by selecting a specified number of data sources (e.g., ten) having the highest similarity scores. Where the user-specified report parameters include one or more preferred third-party data sources 150, the semantic analyzer 215 includes the preferred third-party data source(s) 150 in the selected data sources 150 to query in connection with report generation regardless of whether the similarity score for a preferred data source 150 is among the data sources 150 having the highest similarity scores.

In one embodiment, the data query engine 220 uses Retrieval Augmented Generation (RAG) search techniques to query the vector database, which stores content from the identified third-party data sources 150. Data is collected from these sources and ingested into the vector database at specific intervals, ensuring the database is regularly refreshed with the latest available information. In one embodiment, the data query engine 220 receives a list of Uniform Resource Locators (URLs) from the third-party data store 240 and uses them to identify and retrieve relevant content items. In other embodiments, other suitable mechanisms are used to identify and access third party data sources 150. New data is periodically checked and added to the vector database, maintaining its up-to-date nature. When a user query is submitted, the RAG search is performed on the vector database by matching identified topics or keywords, geographic parameters, and temporal constraints to efficiently retrieve the most relevant content.

Alternatively, the data query engine 220 may receive a list of Uniform Resource Locators (URLs) of the third-party data source 150 websites (e.g., from the third-party data store 240), may access the web sites specified in the URLs, and may send, to each web site, a database query for relevant content items. For example, in one embodiment, a database query includes one or more of identified topics or keywords from the user query, geographic parameters, temporal parameters (e.g., a defined time frame for which the data is to be retrieved), and data characteristics (e.g., textual content, numeric data, metadata, etc.). The data query engine 220 receives, from each third-party data source 150, a response to the database query and processes the received data prior to report generation. In one embodiment, the data query engine 220 performs processing steps including one or more of data cleaning (e.g., removing inaccurate or inconsistent data or removing unwanted elements such as HTML tags, headers, footers, ads, etc.), data integration and normalization (e.g. consolidating data received from the multiple data sources 150 into a unified and consistent dataset), data analysis (e.g., calculating averages, identifying trends, highlighting outliers, etc.), and data filtering (e.g., removing redundant data or less relevant data based on the user's query).

The data query engine 220 sends the processed response data from the data sources 150 to the report generator 225, which generates a report based on the received response data. To do so, the report generator 225 uses a machine-learned model, such as a generative large language model (LLM), that receives as input the processed data received from the data sources 150 and user report parameters (e.g., a preferred report structure, specific sections or topics to address or emphasize, preferred delivery format, etc.) and uses machine-learning techniques to translate the data into a narrative response to the query that presents the responsive information in a logical format and according to any report parameters specified by the user. In one embodiment, the LLM uses a transformer architecture, such as ChatGPT, to generate the report based on the provided input data and parameters.

In one embodiment, where the query includes multiple prompts (e.g. “What is the latest outlook on the Banking sector? How does Everyday Bank compare to competitors in the Banking sector in the US Southeast region?”), the report generator 225 may break down the report generation into multiple sub-topics and address each sub-topic in a separate section of the report (e.g., under individual sub-headings). The report generator 225 constructs the narrative response to the query and applies formatting techniques to define paragraphs of text, headers, bullet points, charts, graphs, tables, or the like to optimize report readability and navigability. Moreover, in some embodiments, the report generator 225 generates a report summary (e.g., identifying key findings) and places the summary at the beginning of the report. Still further, the report identifies the one or more third-party data sources 150 from which the report generation system 110 retrieved the underlying report data.

The interface 205 sends the generated report to the user based on the provided report parameters, such as a specified report format. For example, if the user requested that the report be attached as a PDF sent to the user's email address, the interface 205 generates and sends an email message to the provided email address with the report attached. The email message may include an introduction restating, for example, the user's query, notifying the user of the attached report, and providing a link or other mechanism whereby the user can modify the report parameters if desired.

As discussed above, report parameters specified by the user may include a report interval defining the frequency at which the report should be updated and provided to the user. For example, where the prompt requests information about enterprise competitor activity, the user may wish to receive an updated report on a weekly or monthly basis to ensure that the user remains up-to-date on changes to the competitive landscape. The comparison and update module 230 monitors a duration of time since a previous report was sent to the user and, upon determining that the specified report interval has elapsed, instructs the data query engine 220 to generate and send to the third-party data sources 150 additional database queries requesting updated information responsive to the user query. In some embodiments, the comparison and update module 230 queries the user data store 235 to identify any changes made to the initial report generation request prior to instructing the data query engine 220 (e.g. additional or different data sources 150 to query, an updated competitor list, etc.). The report generator 225 generates an additional report based on the updated information using the method described above, and the interface 205 sends the additional report to the user. In one embodiment, the updated report describes the information or data that is different between a most recent report and a current report to allow the user to easily identify any changes or updates.

The comparison and update module 230 also continually monitors for new data relevant to the initial query by conducting time-staggered RAG searches from one or more data sources, comparing the results between the searches, and determining if significant differences exist warranting report updates. For example, the comparison and update module 230 identifies the occurrence of a user-defined or system-recommended update condition for purposes of providing an updated report to the user outside of the specified report interval (e.g. a “breaking news”-type report). To do so, the comparison and update module 230 instructs the data query engine 220 to send two separate data database queries to each of the identified third-party data sources 150. A first database query specifies a first (e.g., larger) time frame and a second database query specifies a second (e.g., smaller) time frame. For example, the comparison and update module 230 may run a first query requesting responsive data generated over a larger time period, such as the three previous weeks minus the previous day, and run a second query requesting respective data generated over the most recent time period, such as the last day.

The comparison and update module 230 receives from the third-party data sources 150 data sets responsive to the first and second queries and compares the data sets to identify changes or differences between the historical data (i.e., data responsive to the first query) and the recent data (i.e., data responsive to the second query). Various comparison methodologies may be used to evaluate the differences between the respective data sets. For example, for numerical data, the comparison and update module 230 may calculate the mean, median, or mode and compare the calculated values between the two data sets. Additionally or alternatively, statistical variances, standard deviations, or changes in percent value may be calculated. For textual data, the comparison and update module 230 may measure document similarity metrics or changes in sentiment over time.

In one embodiment, the comparison and update module 230 uses provided event triggers that define conditions related to the questions that trigger a report. An agentic AI agent assesses if the report conditions are met by comparing the historic and recent record sets and applying a heuristic based judgment procedure that provides a dichotomous result (yes/no). If the report conditions are met, the system then generates an updated report notifying the user of the observed change relevant to the trigger monitor specified and the user query.

Alternatively, the comparison and update module 230 compares the calculated metrics to a threshold value to determine whether the differences between the first and second data sets exceed a predefined threshold triggering generation of an updated report. The threshold may be user-defined (e.g., as part of the report parameters) or may be set by the report generation system 110. For example, the system 110 may recommend an update threshold for a report based on, e.g., industry trends, recent queries by the user, similar queries by other users, and the like. Moreover, in some embodiments, the threshold value is prompt or query-specific. That is, if a report prompt includes a first question and a second question, the user may define (or the system 110 may automatically recommend or set) different threshold values for the first and second questions (e.g., based on the type of question, the data sources 150 queried in response to the questions, etc.). It should be noted that the similarity metric-based approach and the heuristic-based approach may, in some embodiments, be used interchangeably, and description of one approach herein may equally apply to the other approach.

If a change event is detected by the AI heuristic engine (or, in an alternate embodiment, the comparison and update module 230 determines that the calculated metrics exceed the threshold), the comparison and update module 230 notifies the report generator 225 that an update condition has occurred and instructs the report generator 225 to automatically generate and send an updated report notifying the user of the delta between the first and second data sets (i.e., of the changes that occurred that triggered the updated report). For example, where the initial user query relates to the current outlook on the banking section in Southern California, the updated report might advise the user that the report generation system 110 identified a new development related to the query and provide a summary of the development and the third-party data source(s) 150 from which the underlying data was gathered.

In some embodiments, the comparison and update module 230 may identify differences in the data sets that do not exceed the initial threshold for generation of an automatic report update but may still be of interest to the user. While these differences may be included in a subsequent report according to the defined report threshold (e.g., may be included in a next weekly or monthly report), the user may wish to be notified of them before the next report interval. Accordingly, the threshold for generation of an updated report may be adjusted, e.g., based on user input or automatically by the system based on machine-learning elements. For example, if the report generation system 110 detects the smaller changes often lead to user interactions with the report, the system 110 might lower the threshold accordingly. Alternatively, the system 110 could include a section in the regularly delivered report highlighting changes that did not meet the threshold but may still be of interest to the user.

The user data store 235 is a file storage system, database, set of databases, and/or other data storage system storing information associated with accounts of the report generation system 110. Stored account information may include general user information (e.g., username, password, demographic information, contact information, etc.), information about an enterprise associated with the user, and user activity data on the report generation system 110, such as user query parameters (e.g., previous queries submitted by the user, report frequency settings, identified or preferred data sources, modifications to submitted queries, etc.), and the like. A user may provide input through the interface 205 to update account information, view activity data, change preferred data sources, etc.

The third-party data store 230 is a file storage system, database, set of databases, or other data storage system storing information associated with third-party data sources 150 from which the report generation system 110 mines content. Stored third-party data source 150 information may include an identification of a third-party data source 150, one or more URLs associated with third-party data source 150 website(s), data regarding the frequency with which the third-party data source 150 uploads new content to its website(s), categories into which the third-party data source's content is categorized, user engagement data for the third-party data source's content items, and the like. In one embodiment, the third-party data store 230 also stores lists of third-party data sources 150 from which the report generation system 110 mines content across each geography. The lists may be periodically updated to reflect the addition of new news sources in currently represented geographies, as well as additional distinct geographies.

### Example Interfaces

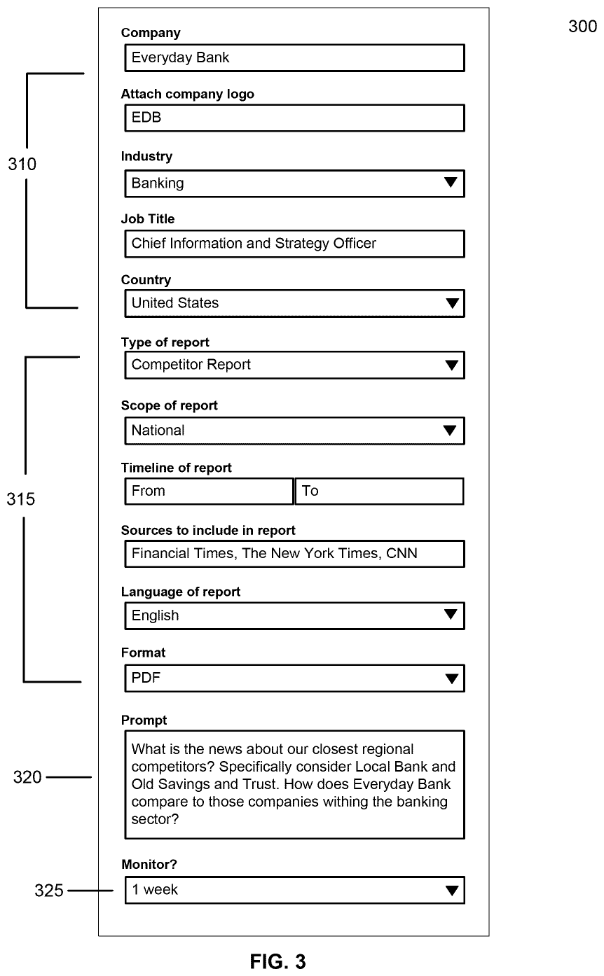

FIG. 3 is an example report request interface 300 displayed on a user device 130 of a user of the report generation system 110. As discussed above, the interface 300 may be displayed via a report generation application 135 or via a web browser executing on the user device 130. The displayed interface 300 includes a plurality of fields for identifying a prompt and report parameters for generation of a report. For example, the fields include enterprise information fields 310 where the user may input the name of a company with which the user is affiliated, a company logo, the company industry, the user's job title, and geographic information, such as the country or countries in which the company operates. Additionally, the fields include report information fields 315 where the user can specify a desired report type (e.g. “Competitor Report”), a geographic scope of the report (e.g., “National,” “International,” “California,” “Southeast United States,” etc.), a report timeline, one or more sources to include in the report, a report language, and a report format (e.g. PDF). In other embodiments, the interface 300 may include different or additional fields, such as a field specifying a report interval, a field identifying or more data sources to exclude from the report generation, a field identifying the enterprise's primary competitors, an update condition, etc. Moreover, as illustrated in FIG. 3, the fields may be drop-down menus where the user may select from a predefined list of options or may be text fields such that the user can provide a free-form response.

The interface 300 also includes a prompt field 320 in which the user may input a prompt defining the scope of the report. The prompt may include one or more questions or instructions that the report generation system 110 uses to identify third-party data sources 150 and associated data used to generate the report. As illustrated, the prompt may instruct the system 110 to consider specific named entities (e.g., enterprise competitors) and/or other entities that the system 110 deems relevant.

The interface 300 also includes a monitor field 325, allowing a user to request that a particular query be monitored, and enabling a user to specify a time period that the query is monitored for. In some embodiments, the interface 300 can additionally allow a user to specify which aspects of the query they want to monitor, what conditions can trigger a regeneration of a report, or any other characteristic associated with generating a report or monitoring subject matter associated with the query.

Responsive to receiving the report request generated via the interface 300, the interface 205 of the report generation system 110 stores the report generation request in association with the user profile in the user data store 235 and sends the request to the preprocessing module 210, as outlined above.

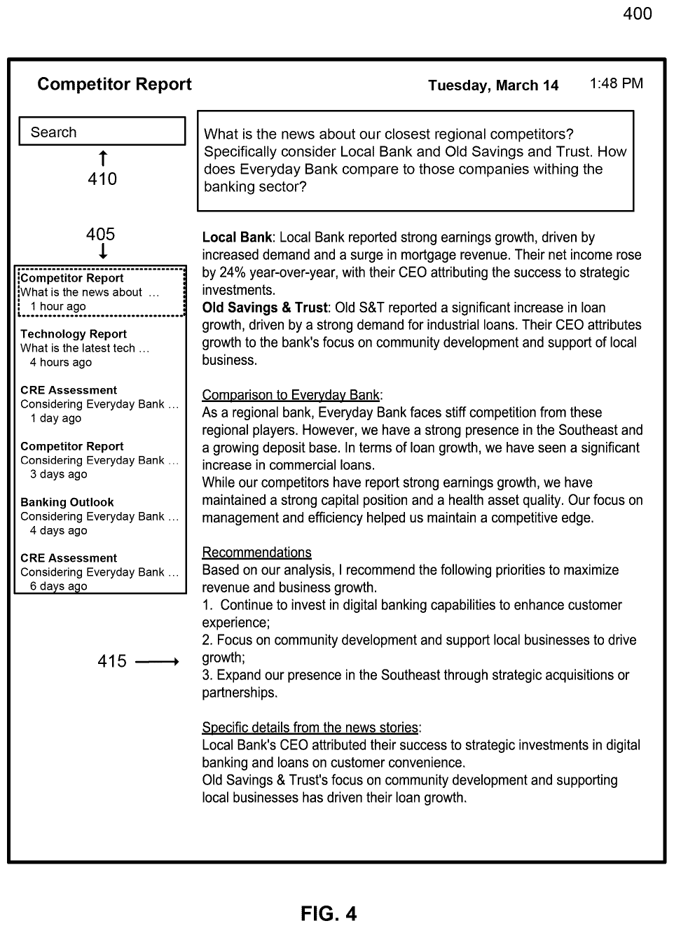

FIG. 4 is an example report interface 400 displayed on a user device 130 of a user of the report generation system 110. As discussed above, the interface 400 may be displayed via a report generation application 135, a web browser 140, or an email application 145 executing on the user device 130. For example, where the report parameters specify that the report should be delivered in the body of an email message, the interface 400 is displayed via the email application 145. In some embodiments, a generated report may be accessible via multiple interfaces on the user device 130. For example, while the report parameters might specify that the user wishes to receive the report via email, the user may also access the report (along with other reports generated for the user) using the report generation application 135. Accordingly, where the interface 400 is displayed via the report generation application 135, the interface 400 includes interface elements 405 that allow the user to toggle between reports, such as previous versions of a current report (e.g., a previous “Competitor Report”) or a different type of report (e.g., “Technology Report,” “Market Assessment,” “Banking Sector Outlook,” etc.). The interface 400 also includes a search field 410 through which the user can search for a specified report.

A selected report is displayed in the main body 415 of the interface 400. As illustrated in FIG. 4, the displayed report includes the date the report was generated, the associated prompt, and the corresponding report. The report may include headings or subheadings responsive to different portions of the prompt to improve readability and allow the user to quickly navigate to a desired report section. Moreover, as discussed above, the report may include a summary (e.g., at the beginning of the report) that provides a high-level overview of the report contents. In the displayed interface 400, the report also includes a comparison between identified competitors and the enterprise associated with the user, recommendations for the associated enterprise, and specific details from the news story content items used to generate the report. While not displayed in the interface 400, in some embodiments, the report may include additional information, such as an identification of and links to the underlying third-party data sources 150, and/or selectable interface elements that the user may use to modify the report parameters.

### Example Methods

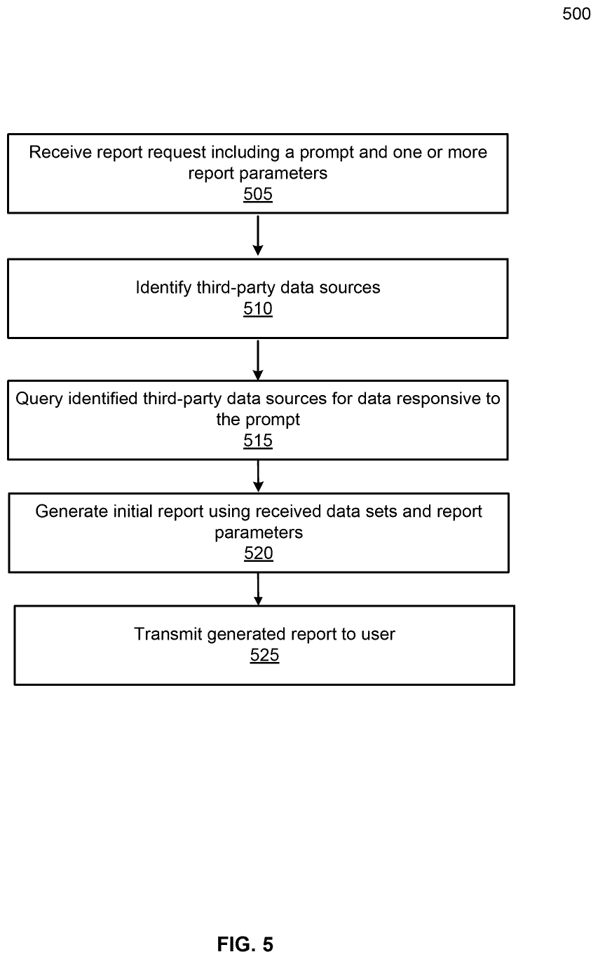

FIG. 5 is a flow chart illustrating a method 500 for generating a report in response to a user query, according to one embodiment. The steps of FIG. 5 are illustrated from the perspective of the report generation system 110 performing the method 500. However, some or all of the steps may be performed by other entities and/or components. In addition, some embodiments may perform the steps in parallel, perform the steps in different orders, or perform different steps.

The method 500 begins with the interface 205 of the report generation system 110 receiving 505 a report generation request from a user. As discussed above, the report generation request includes a prompt and one or more report parameters. The prompt identifies a general area of interest (e.g., the Banking sector) and/or one or more specific queries (e.g., “What is the latest outlook on the Banking sector? How does Everyday Bank compare to competitors in the Banking sector in the US Southeast region?”) to be addressed in a report generated by the report generation system 110. In various embodiments, one or more of the report parameters (e.g., a geographic scope of the report) may be included in the user-specified query or may be provided separately (e.g., in a separate field of a report request interface, as shown in FIG. 3).

After a preprocessing module of the report generation system 110 performs preprocessing operations on the received prompt, the optimized prompt is sent to the semantic analyzer 215, which identifies 510 a corpus of third-party data sources 150 to query for content responsive to the prompt. To do so, the semantic analyzer applies an embedding model that converts the prompt into a numerical vector and generates similarity scores between the vector representing the prompt and vectors representing third-party data sources 150 associated with the report generation system 110. The semantic analyzer 215 uses the calculated scores to select a specified number of data sources 150, such as the ten data sources 150 having the highest similarity scores. As discussed above, however, the corpus of data sources 150 may also be based on user-specified report parameters, such as one or more preferred data sources 150. In various embodiments, a preferred data source 150 replaces a data source selected based on similarity scores (e.g., the example above, the corpus includes the nine data sources 150 having the highest similarity scores plus the preferred data source 150) or is selected in addition to the similarity score-based data sources 150 (e.g., the corpus includes the top ten data sources 150 plus the preferred data source).

The semantic analyzer 215 sends an indication of the identified corpus of data sources 150 to the data query engine 220, which queries 515 the identified data sources 150 for data responsive to the prompt. The data query engine 220 receives, from each third-party data source 150, a responsive data set and sends the received data to the report generator 225, which generates 520 an initial report using the received data sets and the report parameters. To do so, the report generator 225 uses a generative machine-learned model, such as a LLM, that receives as input processed response data from the third-party data sources 150 and the report parameters (e.g., a preferred report structure, preferred delivery format, etc.) and uses machine learning techniques to translate the data into a narrative response to the user prompt. The report generator 225 provides the report to the interface 205, which transmits 525 the report to the user according to the report parameters (e.g., by sending the report in the body of an e-mail message or as an attachment to an e-mail message, via the report generation application 135 executing on the user device 130, etc.).

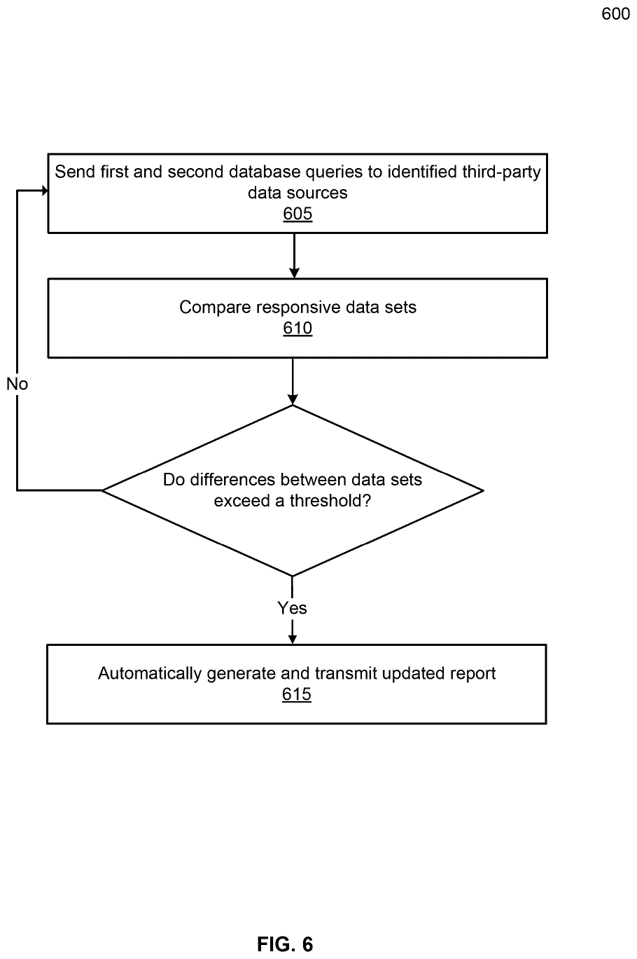

FIG. 6 is a flow chart illustrating a method 600 for automatically updating a report a report responsive to detection of an update condition, in accordance with one embodiment. As discussed above, the comparison and update module 230 routinely monitors the queried data sources 150 associated with a report for new data relevant to the initial query to identify significant changes occurring after a most recent report (e.g., the initial report) was sent to the user. To do so, a two-tiered RAG search is performed and responsive data compared to determine whether an update condition has occurred that warrants generation of an updated report. Specifically, the comparison and update module 230 instructs the data query engine 220 to send 605 first and second database queries to each of the identified third-party data sources 150, where the first database query requests data corresponding to a larger, historical time frame (e.g., the past three weeks minus the most recent day), and the second database query requests data corresponding to a smaller time frame (e.g., the most recent day). In some embodiments, the data query engine 220 uses RAG search techniques to query the data sources 150 and retrieve the requested data.

The data query engine 220 sends responsive data sets from each of the queried third-party data sources 150 to the comparison and update module 230, which compares 610 the data sets to evaluate the differences between the historical and recent data. As discussed above, the comparison and update module 230 may use various comparison methodologies to evaluate the differences between the first and second data sets from a respective third-party data source 150, such as by calculating similarity metrics between the data sets. For example, in one embodiment, the comparison and update module 230 applies a heuristic-based judgment procedure to determine whether one or more report update conditions are met. Alternatively, the comparison and update module 230 compares a calculated metric between the data sets to a threshold value to determine if an update condition is triggered. In either embodiment, responsive to determining that an update condition has occurred, the comparison and update module 230 instructs the report generator 225 to automatically generate and transmit 715 an updated report to the user. The updated report, which is typically generated and transmitted to the user outside of the specified report interval (e.g., as a “breaking news”-type report) notifies the user of the new development or change since the previous report was generated.

If the report conditions are not met the comparison and update module 230 does not automatically generate the updated report but continues to monitor the third-party data sources 150 to identify subsequent updates likely to be of interest to the user. As discussed above, the update condition triggering the “breaking news”-type update may be specified by the user (e.g., as a report parameter) or automatically set by the report generation system 110 and may be adjusted to increase or decrease the threshold value triggering the automatic report updates.

### Example Computer System

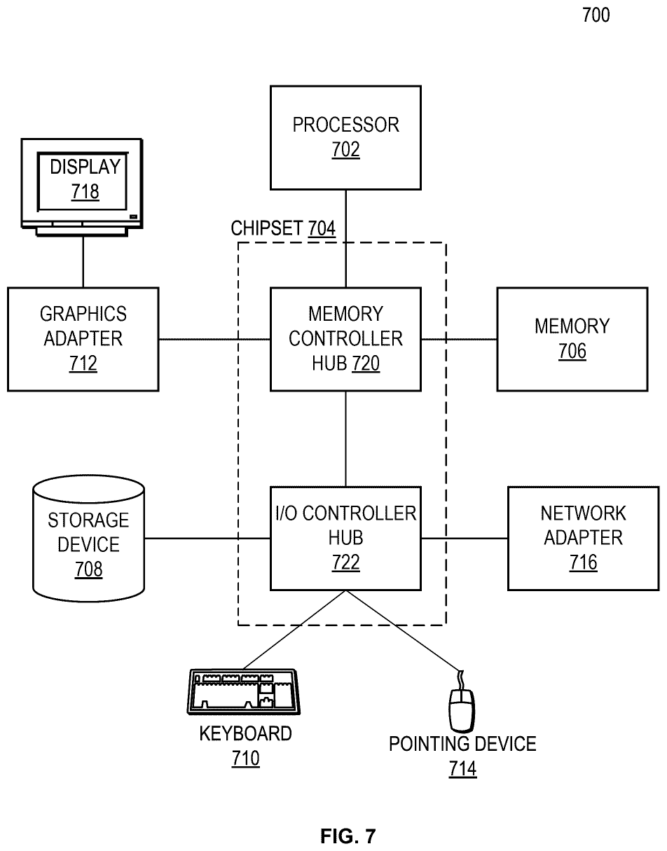

The entities of FIG. 1 are implemented using one or more computers. FIG. 7 is an example architecture of a computing device, according to an embodiment. Although FIG. 7 depicts a high-level block diagram illustrating physical components of a computer used as part or all of one or more entities described herein, in accordance with an embodiment, a computer may have additional, fewer, or variations of the components provided in FIG. 7. Although FIG. 7 depicts a computer 700, the figure is intended as functional description of the various features that may be present in computer systems than as a structural schematic of the implementations described herein. In practice, and as recognized by those of ordinary skill in the art, items shown separately could be combined and some items could be separated.

Illustrated in FIG. 7 are at least one processor 702 coupled to a chipset 704. Also coupled to the chipset 704 are a memory 706, a storage device 708, a keyboard 710, a graphics adapter 712, a pointing device 714, and a network adapter 716. A display 718 is coupled to the graphics adapter 712. In one embodiment, the functionality of the chipset 704 is provided by a memory controller hub 720 and an I/O hub 722. In another embodiment, the memory 706 is coupled directly to the processor 702 instead of the chipset 704. In some embodiments, the computer 700 includes one or more communication buses for interconnecting these components. The one or more communication buses optionally include circuitry (sometimes called a chipset) that interconnects and controls communications between system components.

The storage device 708 is any non-transitory computer-readable storage medium, such as a hard drive, compact disk read-only memory (CD-ROM), DVD, or a solid-state memory device or other optical storage, magnetic cassettes, magnetic tape, magnetic disk storage or other magnetic storage devices, magnetic disk storage devices, optical disk storage devices, flash memory devices, or other non-volatile solid state storage devices. Such a storage device 708 can also be referred to as persistent memory. The pointing device 714 may be a mouse, track ball, or other type of pointing device, and is used in combination with the keyboard 710 to input data into the computer 700. The graphics adapter 712 displays images and other information on the display 718. The network adapter 716 couples the computer 700 to a local or wide area network.

The memory 706 holds instructions and data used by the processor 702. The memory 706 can be non-persistent memory, examples of which include high-speed random-access memory, such as DRAM, SRAM, DDR RAM, ROM, EEPROM, flash memory.

As is known in the art, a computer 700 can have different and/or other components than those shown in FIG. 7. In addition, the computer 700 can lack certain illustrated components. In one embodiment, a computer 700 acting as a server may lack a keyboard 710, pointing device 714, graphics adapter 712, and/or display 718. Moreover, the storage device 708 can be local and/or remote from the computer 700 (such as embodied within a storage area network (SAN)).

As is known in the art, the computer 700 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 708, loaded into the memory 706, and executed by the processor 702.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for operating a data management system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method comprising:
sending, by a report generation system, a first database query to a corpus of third-party data sources that provided data used to generate a report responsive to a user-defined prompt, the first database query requesting data covering a historical time period;
sending, by the report generation system, a second database query to the corpus of third-party data sources, the second database query requesting data covering a recent time period;
calculating, using a trained machine-learned model, a similarity metric between a first data set received responsive to the first database query and a second data set received responsive to the second database query, the model configured to automatically generate numerical similarity scores responsive to differences between processed features of the data sets;
responsive to the similarity metric exceeding a threshold value, automatically generating an updated report responsive to the user-defined prompt; and
sending the updated report to the user.

2. (canceled)

3. The method of claim 1, further comprising:
receiving, at the report generation system, a report request specifying the user-defined prompt and one or more report parameters;
querying, by the report generation system, the corpus of third-party data sources containing data responsive to the user-defined prompt;
generating the initial report responsive to the user-defined prompt based on data sets received from the queried corpus of third-party data sources and the one or more report parameters; and
transmitting the initial report to the user according to the one or more report parameters.

4. The method of claim 1, wherein the corpus of third-party data sources are selected for querying by:
using an embedding model, translating text of the user-defined prompt into a numerical vector;
translating each of a plurality of third-party data sources into a numerical vector;
comparing the vector representing the user-defined prompt with each of the vectors representing the third-party data sources;
generating a similarity score for each third-party data source based on the comparison; and
selecting the corpus of third-party data sources based at least in part on the generated similarity scores.

5. The method of claim 3, wherein the report parameters include one or more of a report format, a delivery format, a report interval, a geographic report scope, a report language, one or more preferred third-party data sources, one or more excluded third-party data sources, and a report update condition.

6. The method of claim 1, wherein a default threshold value is automatically set by the report generation system based on one or more of a topic of the user prompt, previous report requests specified by the user, previous report requests specified by other users of the report generation system, an applicable industry, and the corpus of third-party data sources.

7. The method of claim 3, wherein the trained machine-learned model is a generative machine-learned model, the trained machine-learned model receiving as input the first data set, the second data set, and the one or more report parameters.

8. A non-transitory computer readable storage medium comprising computer executable instructions that when executed by one or more processors causes the one or more processors to perform operations comprising:
sending, by a report generation system, a first database query to a corpus of third-party data sources that provided data used to generate a report responsive to a user-defined prompt, the first database query requesting data covering a historical time period;
sending, by the report generation system, a second database query to the corpus of third-party data sources, the second database query requesting data covering a recent time period;
calculating, using a trained machine-learned model, a similarity metric between a first data set received responsive to the first database query and a second data set received responsive to the second database query, the model configured to automatically generate numerical similarity scores responsive to differences between processed features of the data sets;
responsive to the similarity metric exceeding a threshold value, automatically generating an updated report responsive to the user-defined prompt; and
sending the updated report to the user.

9. (canceled)

10. The non-transitory computer readable storage medium of claim 8, wherein the operations further comprise:
receiving, at the report generation system, a report request specifying the user-defined prompt and one or more report parameters;
querying, by the report generation system, the corpus of third-party data sources containing data responsive to the user-defined prompt;
generating the initial report responsive to the user-defined prompt based on data sets received from the queried corpus of third-party data sources and the one or more report parameters; and
transmitting the initial report to the user according to the one or more report parameters.

11. The non-transitory computer readable storage medium of claim 8, wherein the corpus of third-party data sources are selected for querying by:
using an embedding model, translating text of the user-defined prompt into a numerical vector;
translating each of a plurality of third-party data sources into a numerical vector;
comparing the vector representing the user-defined prompt with each of the vectors representing the third-party data sources;
generating a similarity score for each third-party data source based on the comparison; and
selecting the corpus of third-party data sources based at least in part on the generated similarity scores.

12. The non-transitory computer readable storage medium of claim 10, wherein the report parameters include one or more of a report format, a delivery format, a report interval, a geographic report scope, a report language, one or more preferred third-party data sources, one or more excluded third-party data sources, and a report update condition.

13. The non-transitory computer readable storage medium of claim 8, wherein a default threshold value is automatically set by the report generation system based on one or more of a topic of the user prompt, previous report requests specified by the user, previous report requests specified by other users of the report generation system, an applicable industry, and the corpus of third-party data sources.

14. The non-transitory computer readable storage medium of claim 10, wherein the trained machine-learned model is a generative machine-learned model, the trained machine-learned model receiving as input the first data set, the second data set, and the one or more report parameters.

15. A computer system comprising:
one or more processors; and
a non-transitory computer readable storage medium comprising computer executable instructions that when executed by one or more processors causes the one or more processors to perform operations comprising:
sending, by a report generation system, a first database query to a corpus of third-party data sources that provided data used to generate a report responsive to a user-defined prompt, the first database query requesting data covering a historical time period;
sending, by the report generation system, a second database query to the corpus of third-party data sources, the second database query requesting data covering a recent time period;
calculating, using a trained machine-learned model, a similarity metric between a first data set received responsive to the first database query and a second data set received responsive to the second database query, the model configured to automatically generate numerical similarity scores responsive to differences between processed features of the data sets;
responsive to the similarity metric exceed exceeding a threshold value, automatically generating an updated report responsive to the user-defined prompt; and
sending the updated report to the user.

16. (canceled)

17. The computer system of claim 15, wherein the operations further comprise:
receiving, at the report generation system, a report request specifying the user-defined prompt and one or more report parameters;
querying, by the report generation system, the corpus of third-party data sources containing data responsive to the user-defined prompt;
generating the initial report responsive to the user-defined prompt based on data sets received from the queried corpus of third-party data sources and the one or more report parameters; and
transmitting the initial report to the user according to the one or more report parameters.

18. The computer system of claim 15, wherein the corpus of third-party data sources are selected for querying by:
using an embedding model, translating text of the user-defined prompt into a numerical vector;
translating each of a plurality of third-party data sources into a numerical vector;
comparing the vector representing the user-defined prompt with each of the vectors representing the third-party data sources;
generating a similarity score for each third-party data source based on the comparison; and
selecting the corpus of third-party data sources based at least in part on the generated similarity scores.

19. The computer system of claim 15, wherein a default threshold value is automatically set by the report generation system based on one or more of a topic of the user prompt, previous report requests specified by the user, previous report requests specified by other users of the report generation system, an applicable industry, and the corpus of third-party data sources.

20. The computer system of claim 17, wherein the trained machine-learned model is a generative machine-learned model, the trained machine-learned model receiving as input the first data set, the second data set, and the one or more report parameters.
